(19) United States
(12) Patent Application Publication
(10) Pub. No.: US 2026/0233429 A1
(43) Pub. Date: Aug. 13, 2026

(54) METHOD AND PLANT FOR MANUFACTURING SLAB ARTICLES MADE OF STONE OR STONE-LIKE AGGLOMERATE MATERIAL AND SLAB ARTICLE THUS OBTAINED

(71) Applicant: Luca TONCELLI, Bassano del Grappa (VI) (IT)

(72) Inventor: Luca TONCELLI, Bassano del Grappa (VI) (IT)

(21) Appl. No.: 19/159,253

(22) PCT Filed: Feb. 22, 2024
(86) PCT No.: PCT/IB2024/051710

§ 371 Date: Aug. 22, 2025

(30) Foreign Application Priority Data
Mar. 1, 2023 (IT) 102023000003708

(51) Int. Cl. B28B 1/00; B28B 11/08; B32B 9/00

(52) U.S. Cl. CPC B28B 1/005; B28B 11/0845; B32B 9/002; B32B 2307/536

(57) ABSTRACT

Manufacturing slab articles including steps of distributing a mix layer including a binder and a stone or stone-like granulated material, distributing an additional mix layer with a greater thickness than the mix layer and including a binder and a stone or stone-like granulated material so as to form a sandwich arrangement, compacting the sandwich arrangement, hardening the binders, cooling the sandwich arrangement so as to obtain a hardened slab article in which the surface layer is formed by the mix layer and the main body is formed by the additional mix layer and a step of calibrating the thickness of the article and machining the visible surface of the surface layer. The mix granulated material intended to form the surface layer is acid-resistant and has a hardness at least 5 Mohs, the additional mix granulated material has a content by weight of crystalline silica less than or equal to 10% of the overall weight.

The present invention relates to the technical field for the production of articles made of stone or stone-like agglomerate material and relates in particular to a method for manufacturing slab articles of the aforementioned type.

The invention also relates to a plant for manufacturing slab articles of the type described above and a slab article thus obtained.

In the technical field relating to the production of articles and slabs made of stone or stone-like agglomerate material, the agglomerate is obtained by means of compaction, preferably by means of vacuum vibro-compression, and hardening of at least one mix.

In particular, the articles produced from at least one mix may be made by means of the known Bretonstone® process or by means of rolling, pressing and extrusion.

In the Bretonstone® process, the mix is distributed initially on a temporary support and then subjected to vibration with simultaneous pressing or compression under a vacuum (vacuum vibro-compression) and finally hardened.

The mix contains mainly a binder and granulated material, namely granules and/or powders, consisting of stone or stone-like material.

The binder is preferably of an organic type and consists of a hardening resin chosen from the group comprising polyester resins, acrylic resins, epoxy resins, polyurethane resins, but also resins of natural and plant origin. As an alternative to the organic binding resin a cementitious hydraulic binder may be used.

Moreover, the granulated material consists generally of natural minerals which may of a siliceous nature, namely derived from quartz, granite, porphyry, basalt, quartzites, silica sands, or of a calcareous nature, namely derived from marble, dolomite, coloured stones, etc.

Alternatively, the granulated material of the mixes may consist of synthetic minerals, such as frits, namely amorphous glass, and/or expanded material, such as expanded glass or expanded clay or expanded natural silicates.

The mix may also contain fillers, further binders, additives and colouring agents. In particular, the fillers or mineral fillers are materials used in combination with the resin in order to form the so-called binding paste.

The fillers generally consist of natural or synthetic stone materials of various kinds, which are finely ground, such as ventilated silica or ventilated feldspar for the agglomerates formed with siliceous aggregates, and calcium carbonate or aluminium hydroxide for the agglomerates formed with calcareous aggregates or frits or glass.

Among the various types of materials used to produce the granulated materials and fillers for the mixes, ground quartz in the past has been widely commercialized in the present technical field.

Instead of quartz, cristobalite, quartzites or silica sands may also be used to obtain the granulated materials and fillers for the mixes.

In fact, owing to the transparency of quartz, it is possible to obtain articles which have a very attractive appearance and are extremely scratch-resistant and/or abrasion-resistant and resistant to chemical agents such as acids.

However, the use of quartz, cristobalites, quartzites and silica sands results in the formation of crystalline silica or silicon dioxide (SiO₂) dust during manufacture of the articles.

This dust, when dispersed in the air, may be very damaging and harmful if inhaled, in particular for the workers responsible for manufacturing and machining the articles and may result in a pulmonary disease called silicosis, which may also assume cancerogenic forms.

In order to overcome at least partially this drawback, slab articles which have a stone-like appearance and which use granulated materials which are free or substantially free from crystalline silica have been developed.

For example, the international patent application WO2018/189663 discloses a method for the production of slab articles from mixes in which the granulated materials consist of frits, namely a particular, very hard, semi-transparent, amorphous glass with an appearance similar to quartz.

Said granulated materials, which form the aggregates and the fillers for the mixes, have a hardness which is equal to or greater than 5 Mohs and a content by weight of crystalline silica less than 1% of the overall weight.

Furthermore, the international patent application WO2021/048749 discloses a method for the production of granulated materials suitable for being used for the manufacture of slab articles from a mix.

Said production method comprises mainly a step for melting a mixture of selected minerals, a step for keeping the molten material within a temperature range of between 1030° C. and 1170° C. for a predetermined time period, a step for cooling the molten and cast material and a step for crushing and grinding the cooled material.

The granulated material thus obtained has a crystalline silica content of less than 1% and an intense white colour, with L≥95.

The aforementioned technical solutions, while being widely recognized in the field, are not without a number of drawbacks.

In fact, the methods and processes described above which use granulated materials derived from synthetic minerals which are free or substantially free from crystalline silica consume a particularly large amount of energy and therefore result in a significant increase in the overall costs for the production of slab articles formed entirely by these materials.

A further drawback arising from the use of the aforementioned processes is linked to the fact that the plants for implementing these processes are particularly complex to realize and have particularly long processing times.

Alternatively, slab articles have also been produced from mixes which use granulated materials obtained completely from minerals with a low crystalline silica content, such as feldspars, or minerals derived from glass, including recycled glass, or from marble, or from a combination thereof, these granulated materials being less costly.

By using these materials it is possible to produce slab articles with a low crystalline silica content and reduce the costs for production of said articles.

However, this latter solution also has the following drawbacks:
the slab articles containing feldspars have a crystalline silica content which is in any case greater than the values indicated above with reference to synthetic minerals, are opaque and have a limited transparency, and are therefore not very popular on the market;
instead, the slab articles which use granulated materials obtained from glass, which are known to have a limited hardness, are substantially free from crystalline silica and resistant to acids, but are subject to scratching and abrasion and therefore are also not very popular on the market;
finally, the slab articles which use granulated materials obtained from marble are not acid-resistant or scratch-resistant and are therefore not very popular on the market as well.

The slab articles, which are made by means of the processes indicated above, may also undergo a step involving the application or printing of an ink containing pigments, preferably a disperse ink and/or sublimation ink, on at least one of the surfaces and penetration by means of diffusion of the pigments into the surface layer of the slab in order to form decorations and/or chromatic effects with predefined patterns.

In the context of the present description, the expression “disperse ink” is understood as meaning an ink in which the pigments are intended to undergo a change in state from solid to liquid and/or gaseous or from liquid to gaseous owing to the action of a heat source and/or application of a predetermined pressure, the change in state being exploited in order allow the penetration by means of diffusion into the surface layer of the mixes of the slabs.

Furthermore, in the context of the present description, the expression “sublimation ink” is to be understood as meaning an ink in which the pigments are intended to undergo sublimation, passing from the solid state to the gaseous state as a result of the action of a heat source and/or application of a predetermined pressure in order to allow the aforementioned penetration by means of diffusion into the surface layer of the mixes of the slabs.

The main object of the present invention is to provide a method and a plant for manufacturing slab articles made of stone or stone-like agglomerate material and a slab article thus obtained, which are able to overcome the aforementioned drawbacks.

A particular task of the present invention is to provide a method of the type described above which allows the production of slab articles having a reduced crystalline silica content such as to limit the dispersion of crystalline silica dust during machining of the articles.

A further task of the present invention is to provide a method of the type described above which allows the production of slab articles having a high surface hardness.

Another task of the present invention is to provide a method of the type described above which allows the manufacture of slab articles having a surface which is resistant to acids, wear, scratching, abrasion and impacts.

A further task of the present invention is to provide a method of the type described above able to achieve a reduction in the production costs of slab articles.

Another task of the present invention is to provide a method of the type described above which is able to provide slab articles which have an attractive decorative pattern on the visible face or surface, said decorative pattern being also uniform between the surface and the thickness.

A further task of the present invention is to provide a method of the type described above which allows the manufacture of slab articles which resemble as closely as possible the articles made using natural stone material.

Another task of the present invention is to provide a slab article which has a reduced crystalline silica content such as to limit the dispersion of crystalline silica dust during machining thereof.

A further task of the present invention is to provide a slab article which has high surface hardness and is particularly resistant to scratching, wear, abrasion, impacts and acids.

Another task of the present invention is to provide a slab article which has lower production costs.

A further task of the present invention is to provide a plant of the type described above which has a limited complexity and lower management costs.

The main tasks and object described above are achieved with a method and plant for manufacturing slab articles made of stone or stone-like agglomerate material in accordance with claim 1 and claim 23, respectively, and a slab article thus obtained in accordance with claim 16.

In order to illustrate more clearly the innovative principles of the present invention and its advantages compared to the prior art, some embodiments of a plant for the production of granulated materials (which does not form the subject of the present invention), of a plant and method for the manufacture of the slab articles according to the present invention, and of a slab article obtained by means of the method and the plant of the present invention, will be described below with the aid of the attached drawings. In particular, in the figures:

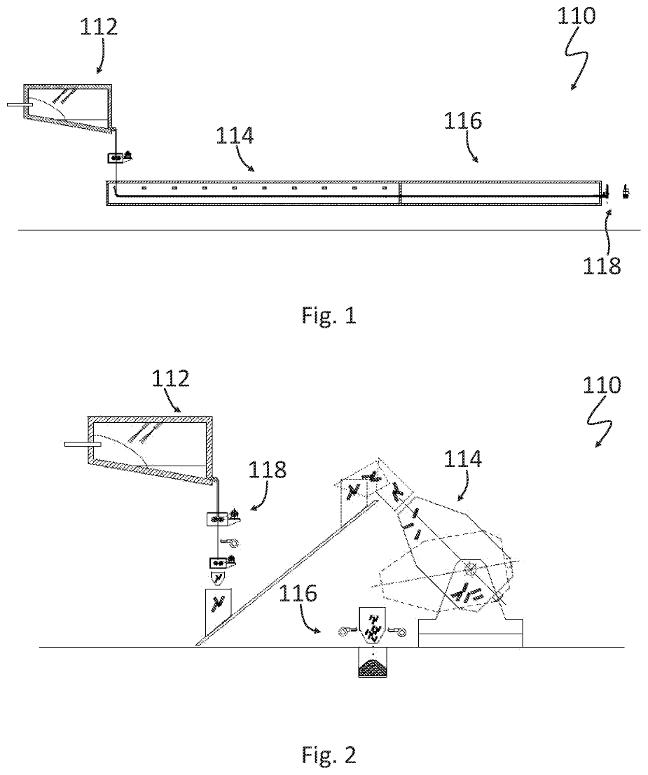

FIGS. 1 and 2 are side views of two alternative embodiments of a plant for the production of granulated materials to be used to obtain the mixes intended for the manufacture of the slab articles;

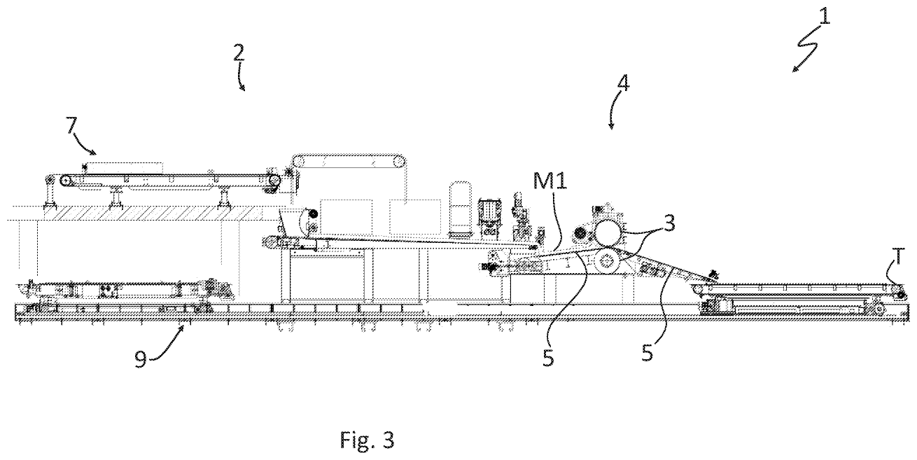

FIG. 3 is a front view of a station of the plant according to the present invention for distribution of a mix in accordance with a first embodiment;

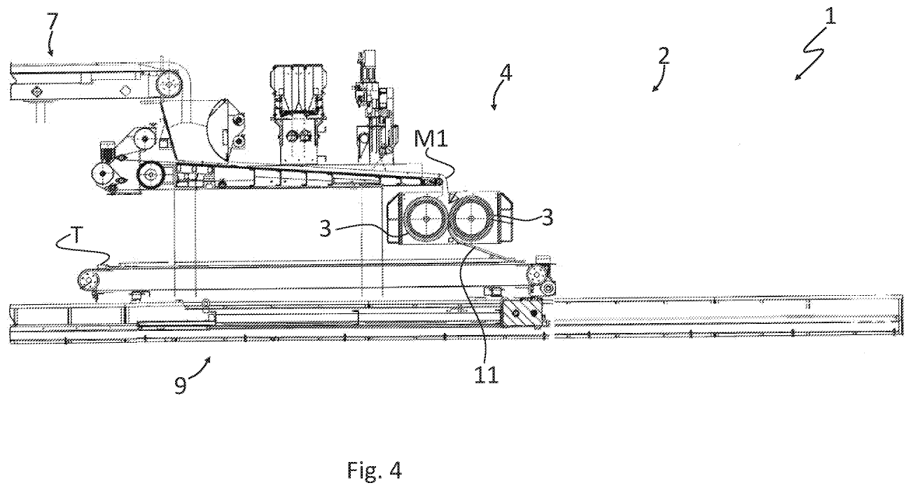

FIG. 4 is a front view of a station of the plant according to the present invention for distribution of a mix in accordance with a second embodiment;

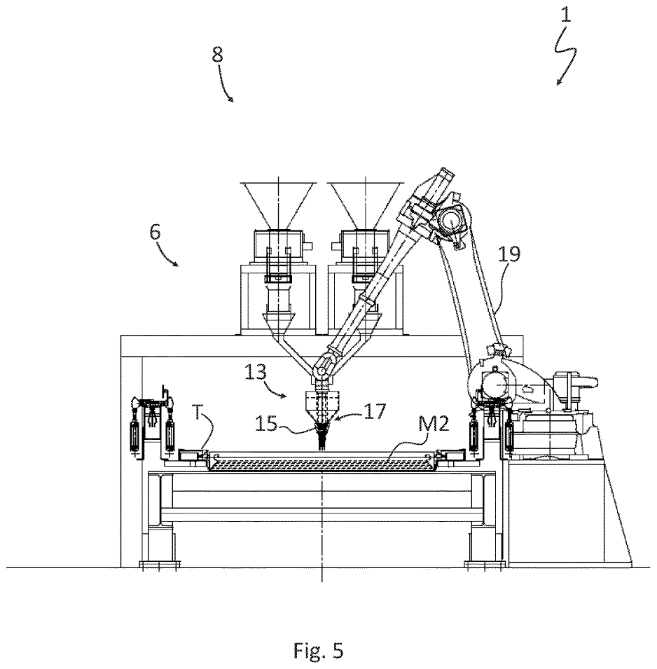

FIG. 5 is a side view of station of the plant according to the present invention for the formation of veining in a mix in accordance with a first configuration;

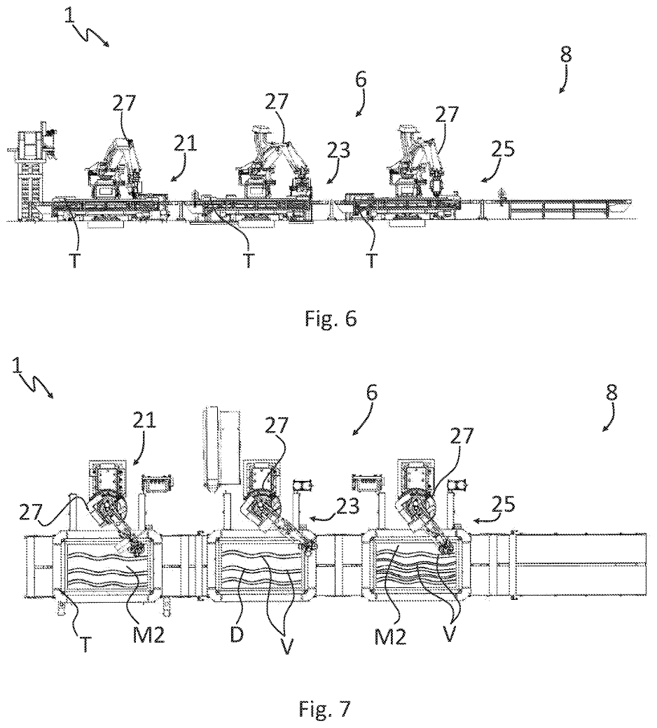

FIGS. 6 and 7 are, respectively, a front view and a top plan view of a station of the plant according to the present invention for the formation of veining in a mix in accordance with a second configuration;

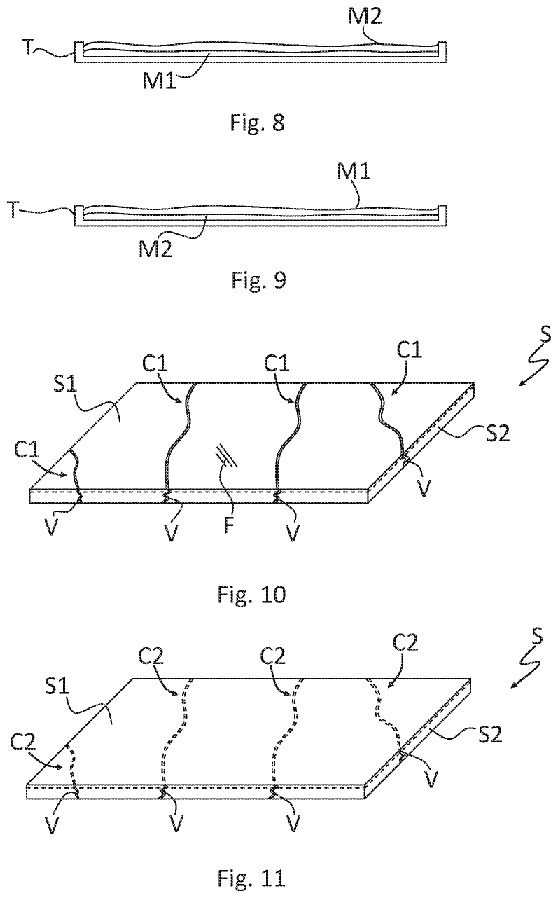

FIGS. 8 and 9 are cross-sectioned front views of a detail of the method according to the present invention in accordance with two alternative embodiments;

FIG. 10 is a schematic perspective view of first embodiment of the slab article according to the present invention;

FIG. 11 is a schematic perspective view of second embodiment of the slab article according to the present invention.

The present description, provided solely by way of a non-limiting illustration of the scope of protection of the invention, relates to a method and a plant for manufacturing slab articles or slabs made of stone or stone-like agglomerate material, and a slab article thus obtained.

Below the plant for manufacturing slab articles will be denoted overall by the reference number 1.

The slab articles are obtained from mixes, these mixes comprising a binder, preferably a binder of the organic type, namely a binding resin, and granulated materials, namely granules and/or powders, of stone or stone-like material.

Preferably, the binder consists of a hardening resin chosen for example from the group comprising polyester resins, acrylic resins, epoxy resins, polyurethane resins, but also resins of natural and plant origin. As an alternative to the organic binding resin a cementitious binder may be used.

The mixes may also contain fillers, further binders, additives and colouring agents. In particular, fillers or mineral fillers are materials used in combination with the binder in order to form the so-called binding paste.

As further explained below, the slab article S according to the present invention may also comprise surface chromatic effects or decorations C1 formed in a surface layer S1 of the slab article or chromatic effects or decorations C2 formed on the body S2 of the slab article S, as shown by way of example in FIGS. 10 and 11, respectively.

As shown in FIG. 10, the surface chromatic effects C1 are preferably produced using a disperse ink, in particular an ink comprising pigments which are intended to undergo a change in state from the solid to liquid/gaseous state or from the liquid state to the gaseous state as a result of the action of a heat source and/or the application of a predetermined pressure. Such a disperse ink is particularly resistant both to chemical agents and to UV rays.

The surface chromatic effects C1 may also be realized by means of a sublimation ink, namely an ink in which the pigments are intended to undergo sublimation, changing from the solid state to the gaseous state owing to the action of a heat source and/or the application of a predetermined pressure.

The pigments of the disperse ink penetrate, by means of diffusion, into the slab article S, in particular in zones or portions of a surface layer S1 of the slab S1 in which the binder is present, as a result of the change in state, to a depth of a few tenths of a millimetre, hence at least partially into the thickness of the slab article S.

In the case of a sublimation ink, the penetration into the surface layer S1 of the slab S occurs following sublimation of the pigments in the ink.

The surface chromatic effects C1 generally consist of a pattern or an image of a natural stone provided with veining so that the slab articles S resemble as far as possible slabs of natural stone material.

Alternatively, as shown in FIG. 11 and as further described below with reference to the alternative embodiment, it is possible to obtain the chromatic effects C2, shown by means of broken lines, formed in the main body S2 of the slab article S, in particular on the surface which makes contact with the surface layer S1.

These effects are obtained by means of digital printing with one or more inks and may also consist of a pattern or image of a natural stone provided with veining.

In this case, the surface layer S1 consists preferably of a mix containing transparent minerals and with a binder, namely a colourless resin, without pigmenting agents and with colourless additives, so as to be transparent after polishing and thus allow the chromatic effects C2 to show through.

As further described below and as shown in FIGS. 10 and 11, the slab article S according to the present invention may also comprise actual veining formed in the thickness, namely in the main body S2, of the slab article S.

The veining V is obtained preferably using at least one liquid or powder colouring agent and/or at least one colouring mix D.

The method comprises mainly the following steps:
distributing a layer of a mix M1 on a temporary support T;
distributing a layer of an additional mix M2 on the temporary support T so as to form a sandwich arrangement or a multilayer intermediate machining product with the layer of mix M1;
compacting the sandwich arrangement formed by the mixes M1, M2 which are distributed on the temporary support T and which will form the slab article S;
hardening of the binders of the mixes M1, M2 and subsequent cooling of the sandwich arrangement in order to obtain a hardened slab article S in which the surface layer S1 is formed by the layer of mix M1 and the main body S2 is formed by the layer of additional mix M2;
calibration of the slab article S and machining of the surface of the surface layer S1 which is intended to remain visible by means of smoothing and/or polishing.

The main body S2 of the slab article S represents the non-visible layer of the article after the latter has been laid in position as required.

In accordance with a first embodiment of the method, the layer of additional mix M2 is distributed subsequently and therefore on top of the layer of mix M1 (see FIG. 8); alternatively, the step of distribution of the layer of mix M1 may be performed downstream of the step of distribution of the additional mix M2 and therefore on top of the layer of mix M2 (see FIG. 9).

In accordance with a particular aspect of the invention, the granulated material of the mix M1 intended to form the surface layer S1 is acid-resistant and has a hardness equal to or greater than 5 Mohs.

Said granulated material may be obtained, for example, from minerals such as quartz, cristobalite, feldspar, granite, quartzite or synthetic minerals.

Furthermore, the granulated material of the main body S2 of the slab article S is obtained from minerals with a content by weight of crystalline silica/silicon dioxide (SiO₂) less than or equal to 10%, preferably less than or equal to 3%, of the overall weight of the granulated material.

Advantageously, the granulated material of the mix M1 intended to form the surface layer S1 of the article S is obtained from synthetic minerals with a content by weight of crystalline silica less than or equal to 1% of the overall weight of the granulated material. Therefore, in this case, the weight amount of crystalline silica in the granulated material of the mix M1 is less than the weight amount of crystalline silica in the granulated material of the additional mix M2 intended to form the main body S2 and in any case both the granulated materials contain a decidedly greater weight amount of silicon dioxide substantially only in amorphous form.

The granulated material of the mix M1 intended to form the surface layer may be obtained for example by means of the method described in Italian patent No. 102019000016043 which comprises essentially the following steps:
melting a mixture of selected minerals having a predetermined chemical composition in order to obtain a molten material and casting the molten material;
holding the molten material at a predetermined temperature, preferably of between 1030° C. and 1170° C. for a predetermined time period;
cooling the molten and cast material to a predetermined temperature;
crushing and/or grinding the material to obtain the granulated material with selected particle size.

For example, the mixture of starting minerals may have the following chemical composition:
62%<SiO₂<70%;
16<CaO<30%;
0.5%<MgO<6%;
2%<Al₂O₃<7%;
1%<K₂O<7%;
0.3%<Na₂O<1.5%.

Optionally the mixture of minerals may also contain oxides in the following weight amounts:
0%<ZrO₂<2%;
0%<B₂O3₃<3%;
0%<ZnO<3%;
0%<BaO<3%;
0%<Li₂O<2%;
0%<P₂O₅<5%.

The aforementioned weight amounts are to be regarded as being in relation to the overall weight of the mixture of minerals and are provided only by way of example.

The granulated material thus obtained has an “absolute” white colour, preferably with L≥95. This effect is obtained by means of a recrystallization process which occurs during the holding step indicated above.

The aforementioned method is obtained, as illustrated for example in FIGS. 1 and 2, by means of a plant 110 preferably comprising:
a furnace 112 for melting the mixture of minerals in order to produce the casting of molten material;
a further furnace 114 for holding the molten and cast material at a temperature of between 1030° C. and 1170° C. for a predetermined time;
means 116 for cooling the material;
means 118 for crushing and/or grinding the material to obtain the granulated material.

FIGS. 1 and 2 show two alternative embodiments of the plant 110 for the production of the granulated material described above, in which the holding furnace 114 in the embodiment shown in FIG. 2 is of the tilting type.

Obviously, the granulated material of the mix M1 intended to form the surface layer S1 may also be different from the material described above, namely not contain synthetic minerals, and may be obtained by means of different processes, provided that it maintains the acid resistance and the hardness indicated above and, where applicable, also the content by weight of crystalline silica indicated above.

Conveniently, the granulated material of the mix M1 intended to form the surface layer S1, which may be obtained with the method indicated above, has a small particle size, of between 0.1 mm and 0.3 mm and preferably between 0.05 mm and 0.15 mm.

The mix M1 intended to form the surface layer S1 and comprising the aforementioned granulated material has a composition formed by a volumetric quantity of binder not less than 22% of the overall volume of the mix and a volumetric quantity of granulated material not greater than 78% of the overall volume of the mix.

The granulated material of the additional mix M2 intended to form the main body S2 of the slab article S is obtained from minerals with a lower content by weight of crystalline silica such as feldspars or minerals obtained from marble or glass, including recycled marble or glass, and/or synthetic minerals and/or expanded material minerals, such as expanded glass or expanded clay or expanded natural silicates or similar materials, or a combination thereof.

Particularly favourably regarded is a slab article S formed by a mix M1 comprising granulated material obtained from synthetic minerals with a content by weight of crystalline silica less than or equal to 1% and by an additional mix M2 comprising granulated material obtained from minerals of marble with a quantity by weight of crystalline silica less than or equal to 3%.

With the aforementioned measures it is possible to obtain a slab article S having:
a very small crystalline silica content such as to limit the dispersion thereof in the form of dust during machining of the article, reducing the risk of silicosis for the operators;
a high surface hardness as well as a greater resistance to wear, abrasion, impacts scratching and acids, in particular on the surface of the surface layer S1 which remains visible following laying of the slab article S;
a cost lower than that of the articles known in the field.

The thickness of the additional layer of mix M2 and therefore of the main body S2 of the slab article S is greater than the thickness of the layer of mix M1 and therefore of the surface layer S1 of the slab article S.

In particular, the surface layer S1 of the slab article S has a thickness of between 0.5 mm and 5 mm and preferably between 1 mm and 3 mm at the end of machining, namely calibration and subsequent smoothing/polishing, of the visible surface.

The aforementioned small thickness values of the surface layer S1 are such that that the separation or the difference from the main body S2 of the slab article S along the edge is almost undiscernible to the naked eye.

In this connection it is pointed out that in the attached FIGS. 10 and 11 the separation between the surface layer S1 and the main body S2 is indicated schematically by means of a broken line for easier understanding; however, as described above, said separation in reality cannot be easily discerned by the naked eye.

Furthermore, the distribution of the mix M1 intended to form the surface layer S1 is performed preferably by means of lamination.

Said measure allows furthermore accurate control and adjustment of the reduced thickness of the surface layer S1 within the aforementioned ranges, this being possible also due to the aforementioned predefined small particle size of the corresponding granulated material.

The distribution of the layer of mix M1 and the distribution of the layer of additional mix M2 are performed by means of respective stations 2 comprising means 4 for distributing the mixes M1, M2.

Advantageously, the mix distribution means 4 are of the type described in international patent application WO2020/058834 and illustrated by way of example in FIGS. 3 and 4.

These distribution means 4 perform the lamination of the mix M1 and will be described again in more detail below with reference to the plant 1 for manufacturing slab articles.

The step of distributing the layer of additional mix M2 may also be performed by means of lamination, using the distribution means 4 described above.

Alternatively, the step of distributing the layer of additional mix M2 may be performed by means of a different traditional distributor, for example of the weight type and without lamination means, not shown in the attached figures.

In this case, after distribution of the additional mix M2, conveniently it is possible to perform a rolling or compression step in order to flatten out the layer of additional mix M2 and so that, after the compaction step, the separation between the surface layer S1 and the main body S2 is sufficiently flat and uniform.

The compaction step, preferably performed by means of vacuum vibro-compression, of the sandwich arrangement of mixes M1, M2 and the cooling step for obtaining the hardened slab articles S are preferably performed in accordance with the known Bretonstone® process and using devices and machines which are known in the field.

The step of hardening the binders is performed by means of catalysis if the binders are of the organic type and is also performed in accordance with the known Bretonstone® process.

Moreover, the mixes M1, M2 preferably use the same amount of organic binder to avoid warping during catalysis of said binders; advantageously the mixes M1,M2 also use the same type of organic binder.

The machining step is performed by means of calibration of both surfaces of the slab article S, while polishing and/or smoothing is/are performed on the surface of the surface layer S1 of the article S intended to remain visible.

Said step is performed by means of machines, devices and tools of the known type, for example by means of abrasive tools mounted on rotatable heads, not shown in the attached figures.

In accordance with a further embodiment, the method may comprise, downstream of the step for machining the visible surface of the surface layer S1, also a step of applying a disperse ink containing pigments, a step of drying the disperse ink and a step of penetration, by means of diffusion, of the pigments of the disperse ink into the surface layer S1 of the slab article S by means of the change in state of the pigments so as to create a series of surface chromatic effects C1, of the type described above. The slab article S thus obtained is schematically shown in FIG. 10.

In this connection, the granulated material of the mix M1 forming the surface layer S1 is colourless or has a light-coloured, preferably white, pigmentation so that the surface chromatic effects C1 are clear and well-marked.

The surface layer S1 of the slab article S comprising the aforementioned granulated material described above therefore also has a colourless appearance or a pigmentation with light-coloured and preferably white tones.

The disperse ink is applied onto the machined surface and penetrates, by means diffusion, into the surface layer S1 of the hardened article S.

The step of applying the disperse ink may be carried out by applying directly the disperse ink onto the surface of the slab article S by means of digital inkjet plotters or printers and may be performed on defined areas of the surface or over the entire surface, depending on the type of chromatic effect C1 to be obtained.

Alternatively, the step of applying the disperse ink onto the surface of the slab article S may be carried out by arranging on the machined surface of the slab a sheet, also known as sublimation sheet, which has, pre-printed thereon, the chromatic effect C1 with the disperse ink to be subsequently applied onto the surface layer S1 of the article S.

In the case of direct application of the disperse ink onto the surface of the article S, said step may be preceded by a step involving the application and drying of a primer on the machined surface of the surface layer S1 of the slab article S.

Preferably, the primer consists of a (preferably aqueous) solution or dispersion, of organic and/or inorganic compounds compatible with the process for direct application of the disperse ink onto the article S.

The drying step may be performed in an oven at a temperature of between 85° C. and 95° C. and for a time period of between 2 and 20 minutes.

Alternatively, the drying step may be performed in a hot-air oven at a temperature close to 110°-120° C. and for a time period of about 60 minutes.

The drying step carried out using the methods described above is able to eliminate the volatile compounds from the (preferably aqueous) solution of disperse ink applied onto the at least one visible surface of the slab article S.

In this way, the dried disperse ink forms a kind of film on the surface of the slab to be decorated, this film having a function similar to the function of the sublimation sheet described above.

As mentioned, during penetration by means of diffusion, the pigments of the disperse ink are intended to undergo a change in state from solid to liquid/gaseous or from liquid to gaseous following the action of a heat source and/or the application of a predetermined pressure.

In the embodiment which envisages the use of a sublimation ink, the diffusion penetration step is performed by means of sublimation of the pigments of the sublimation ink, namely by means of the change from the solid state to gaseous state as a result of the action of a heat source and/or application of a predetermined pressure.

In the present invention, the step involving penetration, by means of diffusion, of the dried sublimation and/or disperse ink is performed preferably in an oven, in particular a hot-air oven.

If the step of drying the disperse and/or sublimation ink is performed at a temperature of between 85° C. and 95° C. as described above, the hot-air oven for performing the ink diffusion penetration step is kept at a temperature of between 150° C. and 200° C. for a time period of between 5 and 30 minutes.

Alternatively, if the drying step is performed at a temperature close to 110° C.-120° C. as described above, the hot-air oven for performing the ink diffusion penetration step is kept at a temperature close to 200° C. for a time period of between 10 and 15 minutes.

The implementation of the drying step at a temperature close to 110°-120° C., which allows the slabs to be heated to a temperature close to 100° C. at the end of the drying step, allows small-size hot air ovens to be used in order to carry out the diffusion penetration step.

The implementation of the steps involving application and drying of the disperse ink and penetration of the pigments is able to avoid or limit the removal of the chromatic effects C1 from the surface during any further machining of the slab article S.

Following penetration of the pigments by means of diffusion there may be envisaged a further cooling step which must be carried out avoiding heat shocks and/or deformations which affect the slab article S.

In order to prevent this from happening, said cooling step is preferably performed using air at room temperature for a duration of at least 60 minutes.

Advantageously, the method also comprises a step for removal of the excess ink which is carried out after the additional cooling step, preferably by brushing with suitable abrasive tools the at least one surface of the slab article S.

The method may also involve the possible application of a layer of functional compound F at least on the machined surface of the surface layer of the slab article S with the surface chromatic effects C1.

The step of application of the layer of functional compound F is performed after both the penetration and cooling step and the step of removal of the excess disperse ink.

The functional compound F of the type indicated above, after being applied onto the surface of the slab on which the chromatic effect C1 has been formed, is allowed to dry and harden so as to form a layer having a thickness of a few microns; therefore said thin layer contains at the end nanoparticles of quartz bonded to the functional groups.

Furthermore, the method may comprise, before application of the layer of functional compound F, a step of polishing the surface of the slab article S onto which the functional compound F will be applied, using fine-grain polishing tools.

The additional mix M2 intended to form the main body S2 of the slab article S has a plain colour or varied colouring.

In this respect, the method may also comprise a step for forming the veining V in the additional mix M2.

As mentioned, the veining V may be realized by means of deposition of a liquid or powder colouring agent or a colouring mix D different from the additional mix M2.

Advantageously, the liquid or powder colouring agent may be distributed inside grooves formed in the at least one layer of additional mix M2 or may be distributed on the layer of additional mix M2 and then mixed with it.

The colouring agent formed by the colouring mix D is solely distributed inside grooves formed in the layer of additional mix M2.

The step of formation of the veining V may be performed by suitable means 6 for formation of the veining in the layer of additional mix M2 of the type described in international patent applications WO2020/115644 and WO2016/113652.

These means 6 for formation of the veining are shown by way of example in FIGS. 5, 6 and 7 and will be described again in detail below with reference to the plant 1 for manufacturing the slab articles S.

Alternatively, in accordance with an embodiment not shown in the attached figures, the step of formation of the veining V may also be performed manually by one or more operators, with the aid, if needed, of suitable devices, such as templates known in the field and/or projectors for projecting onto the mixes images corresponding to the veining V to be formed.

Conveniently, the additional mix M2, before distribution of the mix M1 and following formation of the veining V, is subjected to a flattening action, for example by means of rolling or compression.

As shown in FIG. 10, the chromatic effects C1, namely the veining and the surface designs, are formed on the visible surface of the surface layer S1 with a predefined pattern corresponding to and/or aesthetically compatible with a predefined pattern of the veining V formed in the layer of additional mix M2, namely in the thickness of the main body S2 of the slab article S.

In this way there is no discontinuity between the surface veining of the chromatic effect C1 and the veining V obtained with the colouring agent or with the colouring mix D and formed in the additional mix M2, and the article S, if viewed along its edge, appears, to all intents and purposes, to be made of natural stone material with the veining distributed uniformly throughout its thickness.

In accordance with the alternative embodiment indicated above, the step involving distribution of the mix M1 intended to form the surface layer S1 is performed downstream of the step for distribution of the additional mix M2 intended to form the main body S2 of the slab article S. Therefore, in this latter embodiment, the additional mix M1 is distributed on top of the mix M2 (see FIG. 9).

In this embodiment, the method comprises preferably one or more of the steps carried out downstream of the step for distribution of the additional mix M2 and upstream of the step for distribution of the mix M1 intended to form the surface layer S1:
formation of veining V in the layer of additional mix M2; and/or
pressing and/or rolling of the surface of the layer of additional mix M2 on which the layer of mix M1 of the surface layer S1 will be distributed; and/or
formation of a series of chromatic effects C2 on the surface of the layer of additional mix M2 by means of digital printing with one or more inks compatible with the binders of the mixes.

These chromatic effects C2 correspond to the chromatic effects indicated above and formed on the body of the slab article, as shown in FIG. 11.

It is pointed out that this latter embodiment does not use the disperse or sublimation ink for printing and that, as indicated above, the surface layer S1 has a transparent effect following the smoothing and polishing step, which is designed to reduce the thickness thereof to small values, preferably less than 1 mm, so as to allow the chromatic effects C2 formed at the interface between the main body S2 and the surface layer S1 to be viewed externally.

In this embodiment, the organic binder, namely the resin, of the mix M1 intended to form the surface layer S1 is colourless and is very clear and is free from pigmenting agents, so as to highlight further the chromatic effects C2 underneath the surface layer S1.

Conveniently, the additives of the organic binder are also colourless and very clear.

If the veining V is provided in the main body S2, in this embodiment also, it will have advantageously a predefined pattern corresponding to and/or aesthetically compatible with the predefined pattern of the chromatic effects C2.

This alternative embodiment of the method may comprise, downstream of the step for pressing and/or rolling the surface of the main body S2, a step of applying at least one layer of pigment having a light, preferably white, colour compatible with the binders used in the mixes.

Said pigment may be applied in dry powder form or dispersed in a liquid agent, in which case a following step is provided for drying the liquid agent.

If these latter steps are envisaged, the step of realizing the chromatic effects C2 by means of digital printing using one or more inks is realized on top of the layer of dried pigment. In this way, the final aesthetic effect of the slab article S is further highlighted.

The slab articles S described above and illustrated in FIGS. 10 and 11 also form the subject of the present invention.

Preferably, the slab article S made of stone or stone-like agglomerate material comprises:
the surface layer S1 obtained from a layer of a mix M1 comprising at least one binder and a stone or stone-like granulated material;
the main body S2 obtained from an additional mix M2 also comprising at least one binder and a stone or stone-like granulated material, the main body S2 having a greater thickness than the thickness of the surface layer S1.

The granulated material of the surface layer S1 has a hardness equal to or greater than 5 Mohs and is acid-resistant.

In particular, the granulated material of the surface layer S1 has a Class 4 acid resistance in accordance with the standard EN 14617-10:2012, namely it is a material which maintains at least 80% of the initial reflection value after eight hours of chemical attack.

Furthermore, the granulated material of the main body S2 of the article is obtained from minerals with a content by weight of crystalline silica less than or equal to 10% and preferably less than 3% of the overall weight of the granulated material.

Advantageously, the granulated material of the surface layer S1 may consist, for example, of quartz, cristobalite, feldspar, granite, quartzite or synthetic minerals.

As mentioned above, the granulated material of the surface layer S1 is obtained preferably from synthetic minerals with a content by weight of crystalline silica less than or equal to 1% of the overall weight of the granulated material.

Therefore, the weight amount of crystalline silica in the granulated material of the surface layer S1 is less than the weight amount of crystalline silica in the granulated material of the main body S2.

Conveniently, the granulated material of the mix M1 of the surface layer S1 has a small particle size, ranging between 0.1 mm and 0.3 mm and preferably between 0.05 mm and 0.15 mm.

With reference to the slab article S shown in FIG. 10, the granulated material of the surface layer S1 is colourless or has a light, preferably white, colour and is provided with a series of surface chromatic effects C1, namely surface veining, formed on the surface layer S1 with the disperse or sublimation ink.

Instead, with reference to the slab article S shown in FIG. 11, the surface layer S1 has a transparent effect and the series of chromatic effects C2, namely the veining or decorations, is formed at the interface between the main body S2 and the surface layer S1.

The present invention also relates to a plant 1 for manufacturing slab articles S made of stone or stone-like agglomerate material.

The plant 1 comprises preferably:
a station 2 comprising means 4 for distributing the layer of mix M1 on a temporary support T;
a station 2 comprising means 4 for distributing the layer of additional mix M2 on the temporary support T in order to form the sandwich arrangement;
a station comprising means for compaction of the sandwich arrangement of mixes M1, M2 which are distributed on the temporary support T and which will form the slab article S;
a station comprising means for performing hardening of the binders of the mixes M1, M2;
a station comprising means for cooling the sandwich arrangement so as to obtain a hardened slab article S with a surface layer S1 corresponding to the layer of mix M1 and a main body S2 corresponding to the layer of additional mix M2;
a station comprising means for calibrating the thickness of the slab article S and for machining the slab article S by means of smoothing and/or polishing of the visible surface of the slab article S.

In accordance with the alternative embodiment described above, the station for distribution of the mix M1 is located downstream of the station for distribution of the additional mix M2.

FIGS. 3 and 4 shows two alternative embodiments of the station 2 for distributing the mix M1 and, where applicable, the station 2 for distributing the additional mix M2. As already mentioned, these embodiments are described in international patent application WO2020/058834.

In both these embodiments, the means 4 for distributing the mixes M1, M2 consist of lamination means comprising mainly at least one pair of rolls 3 which have the respective axes of rotation horizontal, vertically spaced and positioned one above the other (see FIG. 3) or horizontal and spaced along the direction of feeding of the mix (see FIG. 4).

The first embodiment also comprises intermediate supporting conveyor belts 5 for conveying the mix from the mix feeding means 7 to the rolls 3 and from the rolls 3 to the temporary supports T in relative movement owing to movement means 9.

The second embodiment comprises instead a conveyor element 11 for conveying the mix having a shaped profile and positioned downstream and in a position underneath the lamination rolls 3.

For the distribution of the additional mix M2, however, means of various types may also be provided for performing distribution without lamination, such as weight distributors or volumetric distributors which are generally used in the industrial field.

The stations for calibrating the thickness of the slab article and/or smoothing and/or polishing the surface of the surface layer S1 of the hardened slab S and the respective means such as, for example, abrasive tools mounted on respective rotating heads, are known per ser and therefore not shown in the attached figures.

The stations for performing the compaction of the mixes, hardening of the binders, preferably by means of catalysis of the organic binders, and cooling of the mixes may preferably consist of the stations commonly used to carry out the Bretonstone® processes and as such will not be further described in the present description.

The plant 1 may also comprise a station 8 comprising means 6 for formation of the veining V in the layer of additional mix M2.

FIGS. 5 and 6 and 7 show, respectively, two alternative configurations of the means 6 for formation of the veining V in the layer of additional mix M2 distributed beforehand on the temporary support T.

In the first configuration shown in FIG. 5, said means 6 comprise a device 13 for distributing the colouring agent, namely a hopper for discharging a powder colouring agent and/or nozzles 15 for spraying a liquid colouring agent.

Said distribution device 13 further comprises a tool 17 intended to interact mechanically with the layer of additional mix M2 in order to form grooves inside which the colouring agent is distributed or to mix the mix on which the colouring agent is distributed.

The distribution device 13 is mounted on suitable movement supports, such as an anthropomorphic robot 19, for relative moment thereof with respect to the advancing surface of the temporary support T containing the mixes M1, M2.

The second configuration shown in FIGS. 6 and 7 comprises preferably a first station with head 21 having a grooving tool for forming grooves in the layer of additional mix M2, a second station with a head 23 comprising a container for distribution of a colouring mix D in the grooves and a third station with a head 25 comprising both a grooving tool and a container for distribution of a further colouring mix D.

The first, second and third stations generally comprise anthropomorphic arms 27 which move the respective heads 21, 23 and 25.

As already mentioned, the veining V may also be realized manually by one or more operators with the aid, where necessary, of suitable devices, such as templates known in the field and/or image projectors.

Downstream, in particular in the case where the additional mix M2 is not distributed by means of lamination, the plant 1 may comprise a station for flattening the additional mix M2 comprising means for pressing and/or rolling said mix M2.

The plant 1 may also comprise a station comprising means for the application, drying and penetration by means of diffusion of a disperse ink containing pigments on the machined surface of the surface layer S1 of the slab article S so as to provide the surface chromatic effects C1 on said surface and, if necessary, a station comprising means for applying a layer of functional compound F onto the same surface of the slab S.

As already mentioned, the means for application of the disperse ink may comprise means for applying the sublimation sheet or digital printers or plotters, not shown in the attached figures, while the ink drying and penetration means may comprise preferably hot-air ovens, which are also not shown in the attached figures.

The means for application of the functional compound may comprise, for example, one or more nozzles and are not shown in the attached figures.

The plant may also comprise a station for application of the primer described above onto the surface of the slab and means for feeding and/or picking up the temporary supports T containing the mixes M1, M2 and/or the slabs S between the various stations.

Alternatively, the plant 1 may comprise a station, not shown in the attached figures, comprising means for performing digital printing with one or more inks, onto the surface of the layer of additional mix M2, flattened beforehand, in order to realize the series of corresponding chromatic effects C2.

Upstream of this latter station there is provided preferably a station comprising means for application, onto the surface of the additional mix M2, the layer of pigment with a light, preferably white, colour in the form of a dry powder or dispersed in a liquid agent which is then dried.

Furthermore, the plant comprises a control unit, not shown in the attached figures, which has installed software and is connected to the various stations.

In particular, the means 6 for formation of the veining V and the means for application of the disperse ink by means of a sublimation sheet or digital printing are controlled by the control unit (in terms, for example, of the trajectories to be followed) so that the veins V of the main body S2 of the slabs S and the chromatic effects C1, C2, namely the surface veins, are realized with predefined patterns which correspond to each other and have a compatible aesthetic effect, allowing also for the retraction of the mixes which occurs during the catalysis step.

The software of the control unit may also comprise at least one artificial intelligence algorithm.

From the above description it is now clear how the plant and the method for manufacturing slabs of stone or stone-like agglomerate material, as well as the slab article thus obtained, are able to achieve advantageously the predefined objects.

In particular, the use of mixes containing granulated materials with a low crystalline silica content, less than or equal to 1% and less than or equal to 10%, preferably equal to 3%, for the surface layer S1 and for the main body S2, respectively, in relation to the overall weight of the granulated materials, reduces significantly the risk of dispersion of crystalline silica dust during machining of the articles.

Furthermore, by obtaining granulated materials from different sources, it is possible to limit the costs for production of the slab articles, while obtaining a performance, in terms of resistance to acids, abrasion and scratching, comparable to the performance of quartz-containing articles.

Obviously, the above description of embodiments applying the innovative principles of the present invention is provided by way of example of these innovative principles and must therefore not be regarded as limiting the scope of the rights claimed herein.

1. A method for manufacturing slab articles made of stone or stone-like agglomerate material comprising the following steps:
distributing a layer of a mix on a temporary support, said mix comprising at least one binder and a stone or stone-like granulated material;
distributing a layer of an additional mix on the temporary support so as to form a sandwich arrangement, said additional mix comprising at least one binder and a stone or stone-like granulated material;
compacting the sandwich arrangement formed by the mixes;
hardening the binders of the mixes;
cooling the sandwich arrangement so as to obtain a slab article in which surface layer is formed by the layer of mix and the main body is formed by the layer of additional mix, said main body having a thickness greater than the thickness of said surface layer;
calibrating the thickness of the slab article and machining the visible surface of the surface layer by means of smoothing and/or polishing;
characterized in that the granulated material of the mix intended to form the surface layer is acid-resistant and has a hardness equal to or greater than 5 Mohs, the granulated material of said additional mix being obtained from minerals with a content by weight of crystalline silica less than or equal to 10% of the overall weight of the granulated material.

2. The method according to claim 1, characterized in that the granulated material of the mix intended to form the surface layer is obtained from minerals comprising one or more of quartz, cristobalite, feldspar, granite, quartzite and synthetic minerals and/or the granulated material of the additional mix intended to form the main body is obtained from minerals comprising one or more of feldspars and minerals obtained from marble or glass or synthetic minerals and/or expanded material minerals comprising one or more of expanded glass and expanded clay and expanded natural silicates or a combination thereof.

3. The method according to claim 1, characterized in that the granulated material of the mix of the surface layer is obtained from synthetic minerals with a content by weight of crystalline silica less than or equal to 1% of the overall weight of the granulated material.

4. The method according to claim 1, characterized in that the granulated material of the mix intended to form the surface layer has a particle size of between 0.1 mm and 0.3 mm.

5. The method according to claim 1, characterized in that said step of distributing the layer of mix intended to form the surface layer is realized by means of lamination of the mix.

6. The method according to claim 1, characterized in that said step of distributing the layer of additional mix intended to form the main body is realized by means of lamination of the additional mix.

7. (canceled)

8. The method according to claim 1, characterized in that the granulated material of the mix of said surface layer is colourless or has a light colour, and further comprising, downstream of said step for machining the visible surface, a step of applying and drying a disperse ink or sublimation ink containing pigments at least on the machined surface and a step of penetration, by means of diffusion, of the pigments of the ink into the surface layer of the slab article by means of a change in state so as to realize a series of surface chromatic effects.

9. (canceled)

10. The method according to claim 8, further comprising a step of forming veining in the additional mix, said chromatic effects being formed on the visible surface of the surface layer with a predefined pattern corresponding to and/or aesthetically compatible with the predefined pattern of the veining.

11. The method according to claim 1, characterized in that the step of distributing the mix intended to form the surface layer is carried out downstream of the step for distributing the additional mix intended to form the main body, the surface layer having a transparent effect following calibration with subsequent smoothing/polishing and the binder of said mix being free from pigmenting agents and containing colourless additives if needed.

12. The method according to claim 11, further comprising, downstream of said step for distribution of said additional mix and upstream of said step for distribution of the mix intended to form the surface layer, one or more of the following steps:
formation of veining in the layer of additional mix; and
pressing and/or rolling of the surface of the layer of additional mix; and
formation of a series of chromatic effects on the surface of said layer of additional mix by means of digital printing with one or more inks.

13. The method according to claim 12, further comprising, downstream of said pressing and/or rolling step, a step of applying at least one layer of pigment having a light colour in the form of a dry powder or dispersed in a liquid agent with subsequent drying of the liquid agent, said step of forming the chromatic effects being performed by means of digital printing on said layer of dried pigment with one or more inks compatible with the binders of the mixes.

14. The method according to claim 11, characterized in that said chromatic effects are formed on the surface of the additional mix with a predefined pattern corresponding to and/or aesthetically compatible with the predefined pattern of the veining formed in the layer of additional mix.

15. (canceled)

16. A slab article made of stone or stone-like agglomerate material, comprising:
a surface layer obtained from a layer of a mix comprising at least one binder and a stone or stone-like granulated material;
a main body obtained from a layer of an additional mix also comprising at least one binder and a stone or stone-like granulated material;
wherein the thickness of the main body is greater than the thickness of the surface layer;
characterized in that the granulated material of the surface layer is acid-resistant and has a hardness equal to or greater than 5 Mohs and in that the granulated material of said main body is obtained from minerals with a content by weight of crystalline silica less than or equal to 10% of the overall weight of the granulated material.

17. The slab article according to claim 16, characterized in that the granulated material of the surface layer is obtained from minerals comprising one or more of quartz, cristobalite, feldspar, granite, quartzite and synthetic minerals and/or the granulated material of the main body is obtained from minerals comprising one or more of feldspars and minerals obtained from marble or glass or synthetic minerals and/or expanded material minerals comprising one or more of expanded glass and expanded clay and expanded natural silicates or a combination thereof.

18. The slab article according to claim 17, characterized in that the granulated material of the surface layer is obtained from synthetic minerals with a content by weight of crystalline silica less than or equal to 1% of the overall weight of the granulated material.

19. The slab article according to claim 16, characterized in that the granulated material of the mix of the surface layer has a particle size of between 0.1 mm and 0.3 mm.

20. The slab article according to claim 16, characterized in that the granulated material of said surface layer is colourless or has a light colour and also is envisaged providing a series of surface chromatic effects formed on said surface layer with a disperse ink or sublimation ink.

21. The slab article according to claim 16, characterized in that the surface layer has a transparent effect, a series of chromatic effects being provided at the interface between the main body and the surface layer.

22. The slab article according to claim 16, characterized in that the granulated material of said surface layer has a Class 4 acid resistance in accordance with standard EN 14617-10:2012.

23. A plant for manufacturing slab articles made of stone or stone-like agglomerate material comprising:
a station comprising means for distributing a layer of a mix comprising at least one binder and a stone or stone-like granulated material on a temporary support;
a station comprising means for distributing a layer of an additional mix comprising at least one binder and a stone or stone-like granulated material on the temporary support so as to form a sandwich arrangement;
a station comprising means for compacting the sandwich arrangement of mixes distributed on the temporary support;
a station comprising means for performing hardening of the binders of the mixes;
a station comprising means for cooling the sandwich arrangement of mixes so as to obtain a hardened slab article;
a station comprising means for calibrating the thickness of the slab article and for machining the article by means of smoothing and/or polishing of the visible surface.

24. The plant according to claim 23, further comprising a station comprising means for the application, drying and penetration by means of diffusion of a disperse ink or sublimation ink containing pigments on the machined surface of the slab article so as to provide thereon a series of surface chromatic effects.

25. The plant according to claim 23, further comprising a station comprising means for digital printing with one or more inks on the flattened surface of the layer of additional mix so as to obtain a series of chromatic effects.

26. The plant according to claim 25, further comprising a station comprising means for applying a layer of pigment having a light colour on the surface of the layer of additional mix.

27. The plant according to claim 23, characterized in that said distribution means for distributing the layer of mix consist of lamination means comprising at least one pair of rolls, and characterized in that said distribution means for distributing the layer of additional mix consist of lamination means comprising at least one pair of rolls.

28. (canceled)
